(19) United States
(12) Patent Application Publication
(10) Pub. No.: US 2024/0082760 A1
(43) Pub. Date: Mar. 14, 2024

(54) FILTRATION SEALING SYSTEM

(71) Applicant: CUMMINS FILTRATION IP, INC., Columbus, IN (US)

(72) Inventors: Caryn J. KINDKEPPEL, Stoughton, WI (US); Brian W. Schwandt, Fort Atkinson, WI (US); Thomas J. Braun, Stoughton, WI (US); Christopher E. Holm, Madison, WI (US); Pathikrit T. Banerjee, Abu Dhabi (AE); Buwa A. Baldeh, Madison, WI (US)

(73) Assignee: CUMMINS FILTRATION IP, INC., Columbus, IN (US)

(21) Appl. No.: 18/508,017

(22) Filed: Nov. 13, 2023

Related U.S. Application Data
(63) Continuation of application No. 16/153,977, filed on Oct. 8, 2018, now Pat. No. 11,833,459.
Application No. 16/153,977 is a continuation of application No. 15/706,138, filed on Sep. 15, 2017, now Pat. No. 10,112,138.
Application No. 15/706,138 is a continuation of application No. 15/236,213, filed on Aug. 12, 2016, now Pat. No. 9,782,708.
Application No. 15/236,213 is a continuation of application No. 14/052,057, filed on Oct. 11, 2013, now Pat. No. 9,623,351.
Application No. 14/052,057 is a continuation of application No. 13/299,419, filed on Nov. 18, 2011, now Pat. No. 9,415,333.
Application No. 13/299,419 is a continuation of application No. 12/420,884, filed on Apr. 9, 2009, now Pat. No. 8,061,530.

(51) Int. Cl. B01D 35/30; B01D 29/01; B01D 46/00; B01D 46/10

(52) U.S. Cl. CPC B01D 35/30; B01D 29/01; B01D 46/0002; B01D 46/009; B01D 46/10; B01D 2201/34; B01D 2201/4046; B01D 2201/4053; B01D 2271/02; B01D 2271/022

(57) ABSTRACT

A inflation sealing system is provided for sealing a filter element in a housing at a mating interface therebetween. The sealing system includes a keyed interface. A replacement filter element is provided for such filtration sealing system, with the replacement filter element including a keyed interface.

### BACKGROUND AND SUMMARY

The invention relates to filtration sealing systems, including filter elements, housings, and replacement filter elements.

Filtration sealing systems are known for sealing a filter element in a housing at a mating interface therebetween. The present invention arose during continuing development efforts in filtration sealing technology, including in the preferred embodiment directed toward improvements in one or more of the following: a system permitting installation or replacement of only an authorized filter element; a system permitting installation or replacement of a filter element only in a given orientation; improved dimensional stability of a gasket and/or housing in sealing relation along a border; a system providing one-way-only fit of a filter element in the housing; replacement filter elements for the above systems; improved sealing along housing ports.

### BRIEF DESCRIPTION OF THE DRAWINGS

FIG. 1 is an exploded perspective view of a filter element in a housing.

FIG. 2 is a perspective view of a component of FIG. 1 and illustrating the present invention.

FIG. 3 is a perspective view of a component of FIG. 1 and illustrating the present invention.

FIG. 4 is an enlarged view of a portion of FIG. 2.

FIG. 5 is an enlarged view of a portion of FIG. 3.

FIG. 6 is an elevation view of an alternate embodiment of a component of FIG. 1 in accordance with the invention.

FIG. 7 is an elevation view of an alternate embodiment of a component of FIG. 1 in accordance with the invention.

FIG. 8 is a sectional view illustrating mating of the components of FIGS. 6 and 7.

FIG. 9 is like FIG. 8 and shows another embodiment.

FIG. 10 is like FIG. 9 and shows another embodiment.

FIG. 11 is like FIG. 1 and further illustrates the embodiment of FIG. 9.

FIG. 12 is like FIG. 1 and further illustrates the embodiment of FIG. 10.

FIG. 13 is like FIG. 1 and shows another embodiment.

FIG. 14 is like FIG. 6 and shows another embodiment.

FIG. 15 is an exploded sectional view of a portion of a component of FIG. 1 and illustrating the present invention.

### DETAILED DESCRIPTION

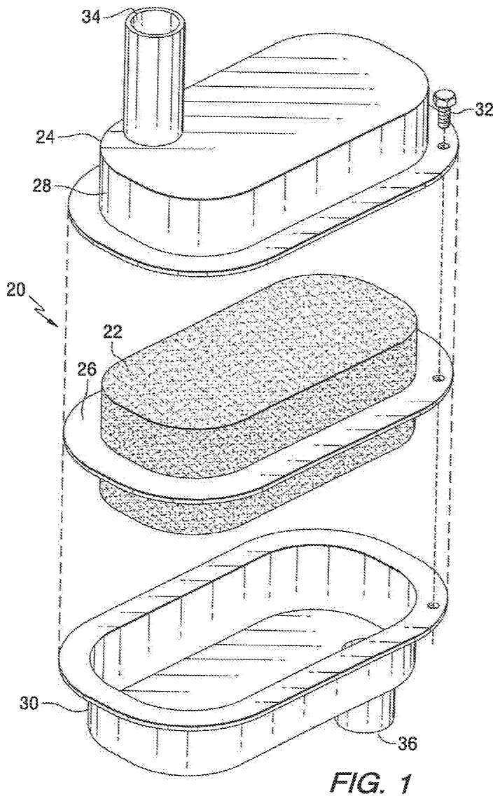

FIG. 1 shows a filtration sealing system 20 for sealing a filter element 22 in a housing 24 at a mating interface such as 26 therebetween, to be described. The housing is provided by mating housing sections 28 and 30 mounted and attached to each other in any suitable manner, such as clamps, bolts (e.g. as shown in dashed line at 32), and so on. The housing has an inlet port 34 for receiving fluid to be filtered, e.g. gas (including air) or liquid, which fluid flows through filter element 22 and is discharged as clean filtered fluid at outlet port 36.

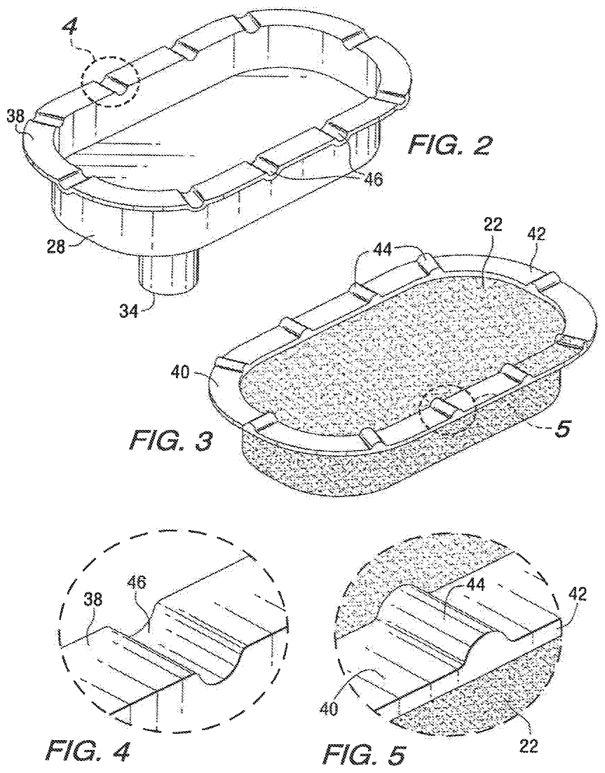

The sealing system includes a keyed interface as shown at 38 in FIGS. 2 and 40 in FIG. 3. FIG. 2 is a perspective view of upper housing section 28 tamed over to view the underside thereof. FIG. 3 is a perspective view of filter element 22 having a border 42 which may be composed of gasket material itself or may have a gasket added thereto. Keyed interface 38, 40 permits installation or replacement of only an authorized filter element 22 mating to the mating interface. The keyed interface permits installation or replacement of the filter element only in a given orientation. Filter element 22 and housing section 28 have borders mating with each other at a gasket 42 therebetween and providing the noted mating interface. The gasket and at least one of the housing and the filter element engage each other in detent relation providing the noted keyed interface. In the embodiment of FIGS. 2, 3 gasket 42 extends along an extension direction along a perimeter. The gasket has one or more humped arches such as 44, FIGS. 3, 5, spaced along the perimeter and extending transversely of the noted extension direction. Housing section 28 has one or more concave recessed slits such as 46, FIGS. 2, 4, spaced along the border along the perimeter and extending transversely of the noted extension direction and complementally receiving respective humped arches 44 therein. The arches and slits may be regularly or irregularly spaced, and may be symmetric or non-symmetric around the perimeter. In one embodiment, gasket 42 is in-molded to and integral with filter element 22. The one or more concave recessed slits 46 are in the housing border. The plurality of humped arches 44 and the plurality of concave recessed slits 46 are in complemental detent relation engagement and are selectively spaced along the perimeter to provide dimensional stability of the housing at the gasket in sealing relation along the border. At least one of the sides, shape and spacing of at least the set of one or more humped arches 44 and the set of one or more concave recessed slits 46 is selectively configured to allow a one-way fit of the filter element in the housing to ensure correct installation every time.

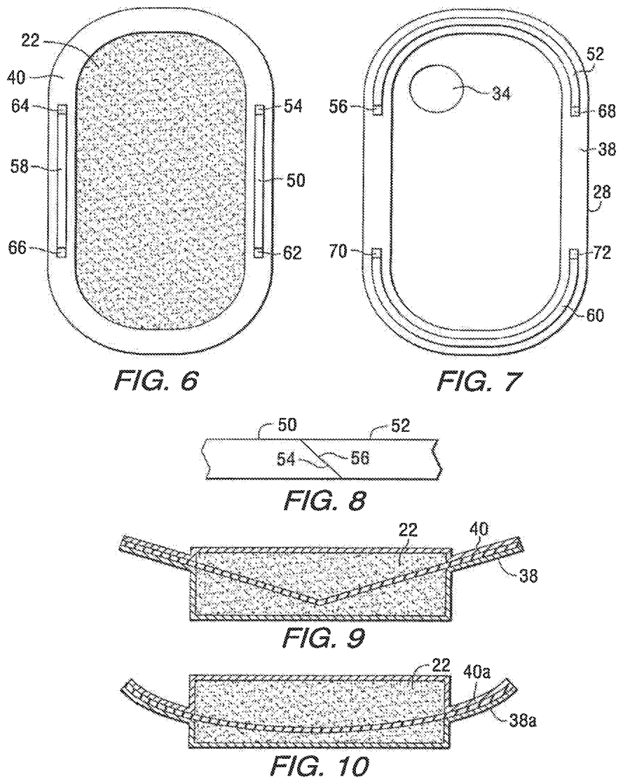

FIGS. 6-8 show a further embodiment and use like reference numerals from above where appropriate to facilitate understanding. At least two gaskets are provided, including a first gasket 50 on the filter element, and a second gasket 52 on the housing. The gaskets engage each other in keyed relation and sealing engagement. The filter element and the housing have borders 40 and 38 mating with each other at two-part gasket 50, 52 therebetween and providing the mating interface. The two-part gasket is provided by at least first gasket 50 and second gasket 52, Gasket 50 has a gasket-engagement surface 54 for engaging gasket 52. Gasket 52 has a gasket-engagement surface 56 for engaging gasket 50. The gasket-engagement surfaces 54 and 56 engage each other in keyed relation providing the keyed interface. The two-part gasket extends along an extension direction along a perimeter. Gasket 50 extends along the extension direction to a beveled end 54 tapered along a first taper along the extension direction. Gasket 52 extends along the extension direction to a beveled end 56 tapered along a second taper along the extension direction. The first and second tapers are opposite and complemental to each other, FIG. 8. The beveled ends at 54 and 56 engage each other in sealed relation at the keyed interface.

In one embodiment, the first gasket includes first and second gasket segments 50 and 58 opposite each other across the perimeter. The second gasket includes third and fourth gasket segments 52 and 60 opposite each other across the perimeter. First gasket segment 50 is between fourth and third gasket segments 60 and 52 along the extension direction along the perimeter. Third gasket segment 52 is between first and second gasket segments 50 and 58 along the extension direction along the perimeter. Second gasket segment 58 is between third and fourth gasket segments 52 and 60 along the perimeter. Fourth gasket segment 60 is between second and first gasket segments 58 and 50 along the extension direction along the perimeter. First gasket segment 50 extends along the extension direction between distally opposite first and second beveled ends 62 and 54 tapered along opposing first and second tapers along the extension direction. Second gasket segment 58 extends along the extension direction between distally opposite third and fourth beveled ends 64 and 66 tapered along opposing third and fourth tapers along the extension direction. Third gasket segment 52 extends along the extension direction between distally opposite fifth and sixth beveled ends 56 and 68 tapered along opposing fifth and sixth tapers along the extension direction. Fourth gasket segment 60 extends along the extension direction between distally opposite seventh and eighth beveled ends 72 and 70 tapered along opposing seventh and eighth tapers along the extension direction. The first and eighth beveled ends engage each other in sealed relation. The second and fifth beveled ends engage each other in sealed relation. The third and sixth beveled ends engage each other in sealed relation. The fourth and seventh beveled ends engage each other in sealed relation.

In some embodiments, the two-part gasket includes only first and second gaskets, with the first gasket extending along the extension direction between distally opposite first and second beveled ends tapered along opposing first and second tapers along the extension direction, and with the second gasket extending along the extension direction between distally opposite third and fourth beveled ends tapered along opposing third and fourth tapers along the extension direction, and with the first and third beveled ends engaging each other in sealed relation, and with the second and fourth beveled ends engaging each other in sealed relation.

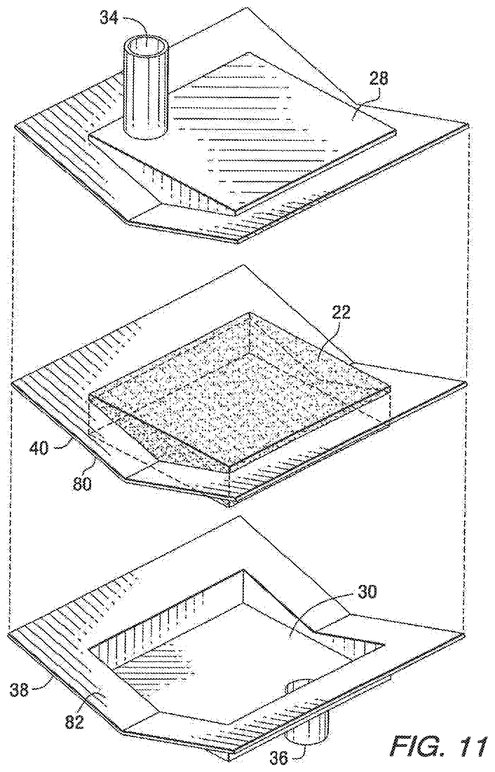

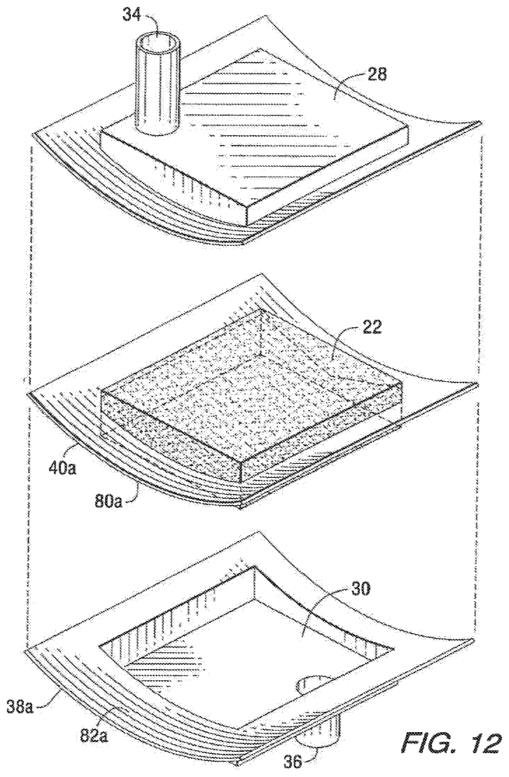

FIGS. 9-12 show further embodiments and use like reference numerals from above where appropriate to facilitate understanding. The filter element and the housing have respective borders 40 and 38 mating with each other at the noted mating interface and extending along an extension direction along a perimeter, FIG. 11. The mating interface has a width extending along a radial direction relative to the perimeter. The mating interface has a length extending along the noted extension direction. The borders have facing surfaces at the mating interface, including a first facing surface 80 on the filter element, and a second facing surface 82 on the housing. At least one of the first and second facing surfaces extends non-rectilinearly along the noted extension direction along the noted length to provide the keyed interface, FIG. 11. In the preferred embodiment, each of the first and second facing surfaces 80 and 82 extends non-rectilinearly along the noted extension direction along the noted length to provide the keyed interface, with one of the facing surfaces, e.g. 82, receiving the other of the facing surfaces, e.g. 80, in nested relation. In FIGS. 9 and 11 the keyed interface has a V-shape in a cross-sectional plane taken transversely to the noted radial direction. In such embodiment, each of the first and second facing surfaces 80 and 82 has the noted. V-shape in the noted cross-sectional plane taken transversely to the noted radial direction, with the V-shape of one of the facing surfaces, e.g. 82, being a concave V-shape relative to the interface, and with the V-Shape of the other of the facing surfaces, e.g. 80, being a convex V-shape relative to the interface, the one facing surface of concave V-shape receiving the other facing surface of convex V-shape in nested relation. In FIGS. 10 and 12, the keyed interface 40a, 38a, at facing surfaces 80a and 82a has an arcuate shape in a cross-sectional plane taken transversely to the noted radial direction. In the preferred embodiment, each of the first and second facing surfaces 80a and 82a has the arcuate shape in the noted cross-sectional plane taken transversely to the noted radial direction, with the arcuate shape of one of the facing surfaces, e.g. 82a, being a concave arcuate shape relative to the interface, and with the arcuate shape of the other of the facing surfaces, e.g. 80a, being a convex arcuate shape relative to the interface, and with the one lacing surface of concave arcuate shape receiving the other facing surface of convex arcuate shape in nested relation.

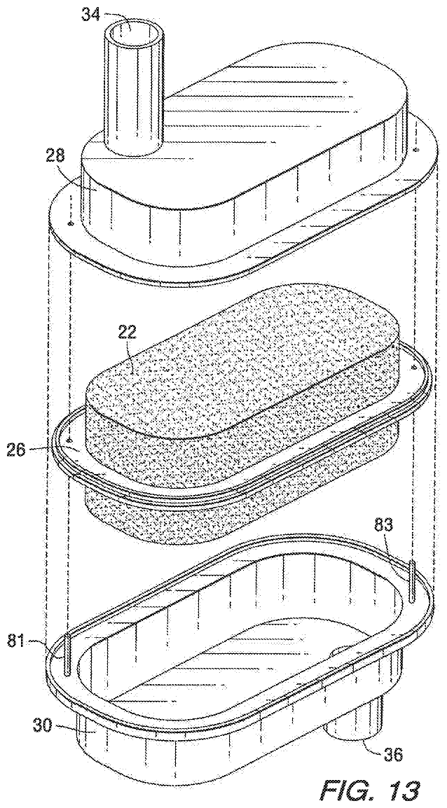

FIG. 13 shows another embodiment having one or more mounting pin locators such as 81, 83 along the borders, providing in one embodiment one or more given or specific orientations of the filter element and the housing. In another embodiment, the one or more mounting pin locators provide one-way-only fit of the filter element in the housing. In another embodiment, the one or more mounting pin locators provide replacement of only an authorized replacement filter element.

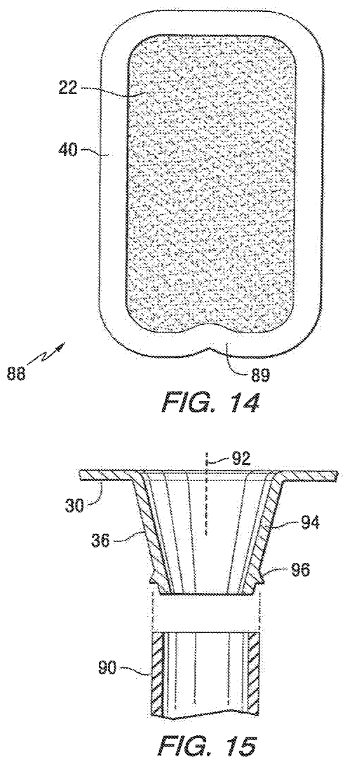

In further embodiments, the filter element and the housing have borders 40 and 38 mating with each other at a seal at the mating interface and extending along the extension direction along a perimeter defining an engagement plane, with each border and the seal having a non-symmetrical shape in the noted engagement plane, such as non-symmetrical shape 88 in FIG. 14, or other non-non-symmetrical shapes. In one embodiment, the seal is provided by a gasket 89, and the gasket follows a non-symmetrical profile. In a further embodiment, the non-symmetrical profile of gasket 89 reduces volume of the housing. In one embodiment, the border has a portion with a heart shape segment, for example as shown at 89. The borders on the filter element and the housing are complemental to each other in the engagement plane, which in combination with non-symmetry provides one-way-only fit of the filter element in the housing. In a further embodiment, the filter element and the housing have borders mating with each other at the mating interface and extending along the extension direction along a perimeter defining an engagement plane and are configured to provide one-way-only fit of the filter element in the housing.

Further in the preferred embodiment, a replacement filter element 22 is provided for the noted filtration sealing system wherein the replacement filter element includes the noted keyed interface. The filter element includes a keyed border providing the keyed interface.

Further in the preferred embodiment, a filtration sealing system is provided fir a filter having a filter element in a housing having at least two sections, the filter element being a first member, the housing sections including second and third members, wherein at least two of the noted members meet at a mating interface, and with the sealing system being a keyed said interface.

The preferred embodiment of the invention further provides a filtration sealing system for a filter having a filter element in a housing having a housing port 36, FIG. 15, connected to a flow conduit 90 for fluid flow therebetween along a flow direction (downwardly in FIG. 15). Port 36 has a length extending along the flow direction, and a width transverse to such length. The width of the port varies along the length of the port, preferably providing a lead-in for assembly into the flow conduit. The port extends longitudinally along a longitudinal axis 92 along the length and has a tapering sidewall 94 which tapers as it extends longitudinally. Tapering sidewall 94 provides the noted varying width. Port 36 tapers frustoconically along tapering sidewall 94. The tapering sidewall has one or more sealing tabs 96 engaging flow conduit 90 in mechanical wiper sealing relation. Conduit 90 may be a resilient flexible material, e.g. rubber, which may stretch as it fits over and around sidewall 94 and sealing tab 96, or conduit 90 may have a frustoconical taper complemental to the frustoconical taper of sidewall 94.

In a further embodiment, the gasket and the housing are configured such that a new gasket may optionally be supplied every time the filter element is replaced. In a further embodiment, the gasket and the housing are configured such that a new gasket must be replaced every time the filter element is replaced. This reduces concern of the gasket taking a compression set over time at the housing and leaking when it interfaces with the filter element. The housing may be provided with one or more snap-fit slits or grooves for receiving the replaceable gasket.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A filter element comprising:
a filter media comprising:
a first face,
a second face opposite the first face, and
at least one side extending between the first face and the second face; and
a filter element border extending along the at least one side and around the filter media, the filter element border having a first arcuate shape in a cross-sectional plane extending through the filter media and substantially orthogonally to the first face and the second face.

2. The filter element of claim 1, wherein:
the filter element border joins with a first portion of the at least one side along a first arc; and
the filter element border joins with a second portion of the at least one side along a first straight line.

3. The filter element of claim 2, wherein:
the filter element border joins with a third portion of the at least one side along a second arc;
the filter element border joins with a fourth portion of the at least one side along a second straight line;
the second portion is disposed between the first portion and the third portion; and
the fourth portion is disposed between the first portion and the third portion.

4. The filter element of claim 3, wherein:
the filter element border is separated from the first face by a first distance along the second portion; and
the filter element border is separated from the first face by the first distance along the fourth portion.

5. The filter element of claim 1, further comprising a first gasket disposed on the filter element border, the first gasket configured to interface with a second gasket of a filter housing to provide a seal.

6. The filter element of claim 1, wherein the filter element border comprises a plurality of projections, each of the projections being configured to be received within a corresponding recess of a filter housing border.

7. The filter element of claim 1, wherein the filter element border does not extend along the first face or the second face.

8. The filter element of claim 1, wherein the filter media is a rectangular prism.

9. A filtration sealing system comprising:
the filter element of claim 1; and
a housing comprising:
a first section comprising a housing first section border, and
a second section mounted to the first section, the second section comprising a housing second section border;
wherein the filter element is disposed between the first section and the second section such that the filter element border is positioned between the housing first section border and the housing second section border.

10. The filtration sealing system of claim 9, wherein:
the filter element further comprises a first gasket disposed on the filter element border; and
the housing further comprises a second gasket disposed on the housing first section border, the second gasket configured to interface with the first gasket to provide a seal between the filter element border and the housing first section border.

11. The filtration sealing system of claim 9, wherein:
the housing first section border has a second arcuate shape in the cross-sectional plane; and
the housing second section border has a third arcuate shape in the cross-sectional plane.

12. The filtration sealing system of claim 9, wherein:
the filter element border comprises a plurality of projections;
the housing first section border comprises a plurality of recesses; and
each of the projections is received within one of the recesses, the projections and the recesses cooperating to resist movement of the filter element relative to the housing.

13. The filtration sealing system of claim 9, wherein:
the housing further comprises:
an inlet port configured to receive a fluid to be filtered, and
an outlet port configured to discharge a filtered fluid; and
the filter element is disposed between the inlet port and the outlet port.

14. The filtration sealing system of claim 13, wherein:
the inlet port extends from a first side of the housing; and
the outlet port extends from a second side of the housing, the second side opposite the first side.

15. The filtration sealing system of claim 9, wherein:
the filter element border joins with a first portion of the at least one side along a first arc; and
the filter element border joins with a second portion of the at least one side along a first straight line.

16. The filtration sealing system of claim 15, wherein:
the filter element border joins with a third portion of the at least one side along a second arc;
the filter element border joins with a fourth portion of the at least one side along a second straight line;
the second portion is disposed between the first portion and the third portion; and
the fourth portion is disposed between the first portion and the third portion.

17. The filtration sealing system of claim 16, wherein:
the filter element border is separated from the first face by a first distance along the second portion; and
the filter element border is separated from the first face by the first distance along the fourth portion.

18. The filtration sealing system of claim 9, wherein the filter element border does not extend along the first face or the second face.

19. The filtration sealing system of claim 9, wherein the filter media is a rectangular prism.

20. The filtration sealing system of claim 19, wherein the filter element border does not extend along the first face or the second face.
